(19) United States
(12) Patent Application Publication
(10) Pub. No.: US 2024/0017636 A1
(43) Pub. Date: Jan. 18, 2024

(54) WIRELESS POWER TRANSFER SYSTEM MAINTENANCE

(71) Applicant: Wireless Advanced Vehicle Electrification, LLC, Salt Lake City, UT (US)

(72) Inventors: Michael Masquelier, Park City, UT (US); Steven Ball, Sandy, UT (US); Arash Rasteh, Herriman, UT (US)

(21) Appl. No.: 17/866,496

(22) Filed: Jul. 16, 2022

(51) Int. Cl. B60L 53/66; G06Q 10/00; G07C 5/08

(52) U.S. Cl. CPC B60L 53/66; G06Q 10/20; G07C 5/0808

(57) ABSTRACT

Methods, systems, and apparatus, including computer programs encoded on a computer storage medium, for maintaining wireless power transfer systems are disclosed. In one aspect, a method includes the actions of receiving, from an electric vehicle and from an electric vehicle charger, electric vehicle sensor data that reflects a characteristic of the electric vehicle and electric vehicle charger data that reflects a characteristic of the electric vehicle charger. Based on the electric vehicle sensor data and the electric vehicle charger data, the actions further include determining that a component of the electric vehicle or a component of the electric vehicle charger should be repaired or replaced. The actions further include providing, for output, data indicating that the component of the electric vehicle or the component of the electric vehicle charger should be repaired or replaced.

### BACKGROUND

Wireless power transfer is the transfer of electrical power without wires as a physical link. A wireless power transfer system includes a transmitter device and a receiver device. The transmitter device is driven by a power source and generates an electromagnetic field. The receiver device extracts power from the electromagnetic field and supplies the power to an electrical load.

### BRIEF DESCRIPTION OF THE DRAWINGS

The detailed description is described with reference to the accompanying figures, in which the left-most digit(s) of a reference number identifies the figure in which the reference number first appears. The use of the same reference numbers in different figures indicates similar or identical items.

FIG. 1 illustrates an example wireless power transfer system that is configured to identify maintenance issues of the wireless power transfer system and/or an electric vehicle.

FIG. 2 illustrates an example server that is configured to identify maintenance issues of a wireless power transfer system and/or an electric vehicle.

FIG. 3 illustrates an example vehicle that is configured to identify maintenance issues of an electric vehicle.

FIG. 4 is a flowchart of an example process for identifying maintenance issues of a wireless power transfer system and/or an electric vehicle.

### DETAILED DESCRIPTION

Electric vehicles, like any other vehicles, are made of various components that need to be repaired or replaced during the life of the vehicle. Some components may provide an indication that they need to be replaced such as when worn brake pads or shoes begin making a metallic grinding or squealing noise. Other components may provide no indication of needing repair or replacement before they fail. For example, a receiving pad of an electric vehicle may continue to receive wireless power from a charging pad up to the point of failure. Once the receiving pad fails, then the vehicle may be unable to charge. It would be beneficial to be able to determine when a component is deteriorating in performance or about to fail so that the component can be repaired or replaced in advance.

An electric vehicle may be equipped with various sensors. The sensors may monitor the characteristics of the vehicle and the environment in and around the vehicle. Some sensors may be configured to monitor characteristics of the battery such as voltage, current, temperature, capacity, and other similar characteristics. Other sensors may be configured to monitor characteristics of the receiving pad such as electrical frequency, temperature of various components of the vehicle, temperature outside the vehicle, voltage, current, humidity, and other similar characteristics. The vehicle may also include sensors that monitor the location of the vehicle, brake usage, throttle usage, tire pressure, seatbelt usage, air conditioner usage, cabin and ambient temperature, cabin and ambient humidity, and other similar characteristics.

The vehicle or another device may monitor the sensor data from the vehicle and determine when a component is likely to fail in the near future. The vehicle or other device may analyze the sensor data using various models. These models may be trained using machine learning and previous sensor data collected from vehicles that had components repaired or replaced. The models may identify a component that is likely to fail in the future and a likely time period before the component fails. If a component is likely to fail in the future, then the vehicle or other device may output a recommendation to repair or replace the component. A user may receive the recommendation and repair or replace the component, thus preventing any problems or inconveniences beyond the repair.

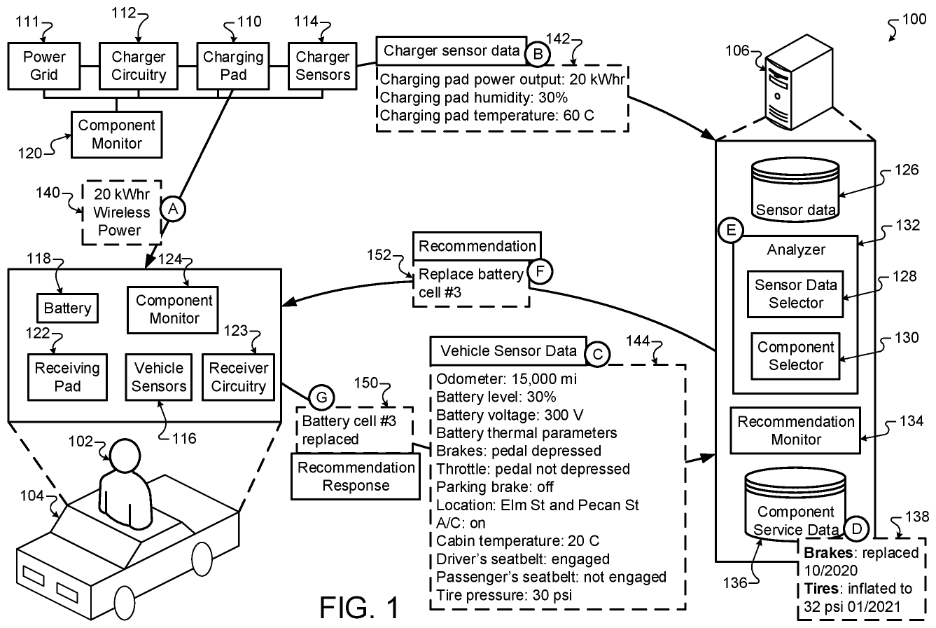

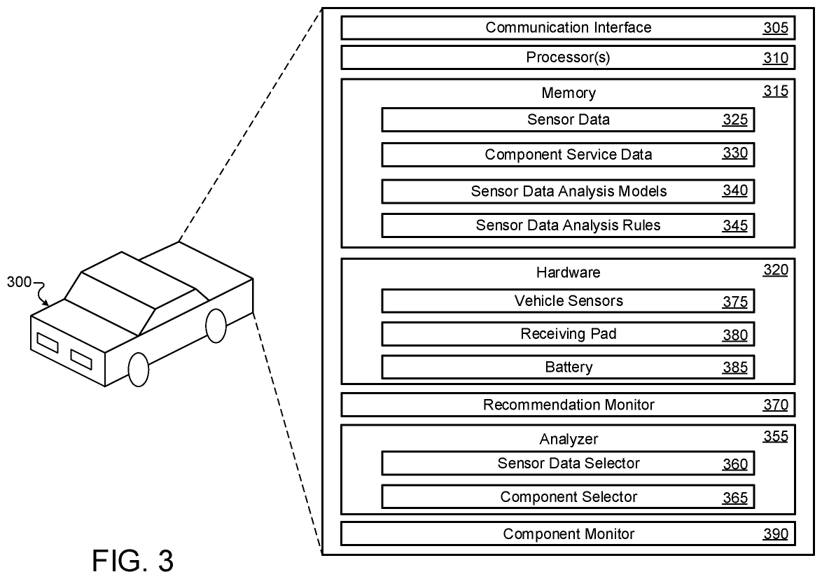

FIG. 1 illustrates an example wireless power transfer system 100 that is configured to identify maintenance issues of the wireless power transfer system 100 and/or an electric vehicle 104. Briefly, and as described in more detail below, the wireless power transfer system 100 includes a charging pad 110 that is configured to provide power wirelessly to the electric vehicle 104. The electric vehicle 104 may include vehicle sensors 116 that collect vehicle sensor data 144 related to the electric vehicle 104. The charging pad 110 and the associated charger circuitry 112 may communicate with charger sensors 114 that collect charger sensor data 142 related to the charging pad 110 and the associated charger circuitry 112. The server 106 may receive and analyze the vehicle sensor data 144 and the charger sensor data 142 and identify any maintenance issues related to the charging pad 110, charger circuitry 112, and/or the electric vehicle 104. The server 106 may generate a recommendation to repair or replace a component of the charging pad 110, the charger circuitry 112, and/or the electric vehicle 104 if the server 106 identifies a maintenance issue. In some instances, the server 106 may automatically implement the repair or replacement. In some implementations and as discussed below with respect to FIG. 3, the vehicle 104 may be configured to identify the maintenance issue and automatically implement the repair or replacement. FIG. 1 includes various stages A through G that may illustrate the performance of actions and/or the movement of data between various components of the wireless power transfer system 100. The wireless power transfer system 100 may perform these stages in any order.

In more detail, the user 102 may be operating the vehicle 104. The vehicle 104 may be any type of motorized vehicle such as a car, truck, van, bus, train, motorcycle, electric bicycle, scooter, tractor, drayage truck, street sweeper, watercraft, electric vertical take-off and landing (eVTOL) aircraft, or any other similar type of vehicle. In some implementations, the vehicle 104 may be any type of device that includes a motor and a battery such as a lawnmower, tiller, generator, snow blower, and/or any other similar type of device.

The vehicle 104 may include a receiving pad 122, associated receiver circuitry 123, and a battery 118. The receiving pad 122 may be configured to receive power wirelessly from a charging pad 110. The charging pad 110 may receive power from the charger circuitry 112 and transfer the power to the receiving pad 122. The charger circuitry 112 may receive power from the power grid 111. The receiver circuitry 123 may include converters, inverters, and/or control circuitry to transfer power from the receiving pad 122 to the battery 118. The charging pad 110 and the receiving pad 122 may include coils that are configured to couple together at a resonant frequency during the transfer of the wireless power 140. The charging pad 110 and the receiving pad 122 may also include magnetic material and/or metal in order to improve the transfer of the wireless power 140 and to prevent the wireless power 140 from affecting or being affected by nearby people, animals, and/or devices. The coils of the charging pad 110 and the receiving pad 122 may include components of resonators that resonate at the resonant frequency. These components may be electrical components that include, for example, capacitors, inductors, and resistors. At the resonant frequency, the transfer of the wireless power 140 may be more efficient than at other frequencies. In some implementations, the charging pad 110 may be configured to transfer power to the receiving pad 122 without coupling together at the resonant frequency. In some implementations, the vehicle 104 may provide power to various electronic devices such as mobile phones, cameras, power converters, and/or any other similar type of device. These devices may draw power from the battery 118. The power grid 111 may be operated by a utility company. The utility company may operate a power plant and use transmission lines to deliver power to the charger circuitry 112. The power plant may generate electricity using coal, natural gas, solar, wind, water, and/or any other renewable or nonrenewable source. In some implementations, the charger circuitry 112 may be connected a power source such as solar panels. In this case, the charger circuitry 112 may not be connected to the power grid of a utility company and may receive its power from solar panels that may be in the vicinity of the charger circuitry 112. For example, the solar panels may be on top of a car port that may cover the vehicle 104 when the vehicle 104 is receiving power from the charging pad 110.

The receiving pad 122 may receive the wireless power 140 from the charging pad 110. The charging pad 110 may receive power from the charger circuitry 112. The charger circuitry 112 may include various power conversion, power inversion, and/or control circuitry that transfers power from the power grid 111 to the charging pad 110. The charging pad 110 and charger circuitry 112 may be configured to transfer power at various rates, such as, for example, eleven, fifty, one hundred, and/or five hundred kilowatts. In the example of FIG. 1 and in stage A, the charging pad 110 may transfer twenty kilowatt-hours of wireless power to the receiving pad 122. The receiving pad 122 may provide the wireless power 140 as alternating current power to a converter of the receiver circuitry 123 that converts the alternating current power of the wireless power 140 to direct current power. The receiving pad 122 may provide the twenty kilowatt-hours of wireless power to the converter of the receiver circuitry 123 less some energy that may be lost as heat, leakage, rectification, and though other inefficiencies in the vehicle 104. The converter of the receiver circuitry 123 may receive the approximately twenty kilowatt-hours of wireless power and store energy (e.g., as chemical energy) in the battery 118.

The charger sensors 114 may be configured to collect charger sensor data 142 that reflects the characteristics and operations of the charging pad 110 and/or the charger circuitry 112. The charger sensors 114 may include various types of sensors such as power meters that measure the power provided by the power grid 111 to the charger circuitry 112, power provided by the charger circuitry 112 to the charging pad 110, and power provided by the charging pad 110 for receipt by the receiving pad 122. The power meters may also measure power provided to other vehicles. The charger sensors 114 may include thermometers that measure the ambient temperature and/or the temperature of any component of the charging pad 110 and/or the charger circuitry 112. The charger sensors 114 may also include location sensors that determine the location of the charging pad 110 and/or the charger circuitry 112, a hygrometer that measures the moisture content of the ambient air and/or the air inside any component of the charging pad 110 and/or the charger circuitry 112, such as inside the charging pad 110, and/or a water sensor that may detect the presence of water in and/or around the charging pad 110 and/or the charger circuitry 112, to name some examples. The charger sensors 114 may also include alignment sensors that detect an orientation between the charging pad 110 and the receiving pad 122. For example, an alignment sensor may determine that the centers of the charging pad 110 and the receiving pad 122 are offset by three inches and/or that the charging pad 110 and the receiving pad 122 are seven inches apart. The charger sensors 114 may also include devices to monitor the current, frequency, voltage, and/or temperature of the various components of the charging pad 110 and charger circuitry 112 including the coil, inverter, converter, and/or other components. In addition, the charger sensors 114 may timestamp the charger sensor data 142. The timestamps may indicate a date and time at which a sensor detected a certain condition and may also indicate the charging activity of the charging pad 110. For example, the timestamps may indicate that the charging pad 110, which may be capable of outputting eleven kilowatts, was outputting seven kilowatts at a first time and for a period after the first time and outputting ten kilowatts at a second time and for a period after the second time.

The charger circuitry 112, charging pad 110, charger sensors 114, and/or power grid 111 may communicate with a component monitor 120. The component monitor 120 may be configured to determine whether a component of the charger circuitry 112, charging pad 110, charger sensors 114, and/or power grid 111 has likely been previously repaired and/or replaced by monitoring the location of that component. In some implementations, various components of the charger circuitry 112, charging pad 110, charger sensors 114, and/or power grid 111 may be located near a proximity sensor. The proximity sensor may output data indicating whether the component is near the proximity sensor. The component monitor 120 may determine that a component has been replaced or repaired when the proximity sensor indicates that the component is not near the proximity sensor for at least a threshold period of time. In some implementations, the component monitor 120 may receive input from a user when the user repairs a component but does not remove the component in which case the output of the proximity sensor does not change.

As illustrated in FIG. 1 and in stage B, the charger sensors 114 may provide the charger sensor data 142 to the server 106 at periodic intervals such as every hour, in response to a request from the server 106, and/or during or after charging the vehicle 104 or any other vehicle, for example, in real time, or at any other time. In some implementations, the charger sensor data 142 may indicate, for example, the amount of power received by the charger circuitry 112 from the power grid 111, the charging pad 110 output twenty kilowatt-hours of power, the humidity inside the charging pad 110 is thirty percent, and the temperature of the charging pad is sixty degrees Celsius. In some implementations, the charger sensor data 142 may include repair and/or replacement data generated by the component monitor 120. In some implementations, the component monitor 120 may provide the repair and/or replacement data to the server 106 in response to determining that a component has been repaired and/or replaced.

The vehicle sensors 116 may be configured to collect vehicle sensor data 144 that reflects the characteristics and operations of the vehicle 104. For example, the vehicle sensors 116 may include an odometer that measures the number of miles driven by the vehicle 104 and/or the number of miles driven by the vehicle 104 since the last charge from the charging pad 110 or another similar charging device. The vehicle sensors 116 may include a location sensor that determines the location of the vehicle 104. The vehicle sensors 116 also may include vehicle accessory monitors that may monitor the usage of various accessories of the vehicle 104. These accessories may include headlights, interior lights, air conditioning systems, heating systems, audio recording and output systems, video recording and output systems, automatic door operators, and/or any other similar vehicle accessory. The vehicle sensors 116 may further include devices to monitor the current, frequency, voltage, and/or temperature of the various components of the receiving pad 122, battery 118, and vehicle 104 including the coil, inverter, converter, and/or other components. In addition, the vehicle sensors 116 may include battery level monitors that measure the capacity of the battery 118 and the power of the battery 118, a voltmeter that measures the voltage of the battery 118, an ammeter that measures the current of the battery 118, and/or various thermometers that measure the temperature of various components of the vehicle 104. For example, thermometers may measure the temperature of various portions of the battery 118, various portions of the electric motor, the ambient temperature, the cabin temperature, and any other similar locations. The vehicle sensors 116 may also include a hygrometer that measures the moisture content of the ambient air, the cabin air, and/or the air inside any component of the vehicle 104; and/or a water sensor that may detect the presence of water in and/or around any component of the vehicle 104 including the receiving pad 122. The vehicle sensors 116 may timestamp the vehicle sensor data 144. The timestamps may indicate a date and time at which a sensor detected a certain condition.

The vehicle 104 may include a component monitor 124. The component monitor 124 may be similar to the component monitor 120 and may be configured to determine whether a component of the vehicle 104 has likely been previously repaired and/or replaced by monitoring the location of the component over time. In some implementations, various components of the vehicle 104 may be ordinarily located near a proximity sensor. The proximity sensor may output data indicating whether the component is near the proximity sensor. The component monitor 124 may determine that a component has been replaced or repaired when the proximity sensor indicates that the component is not near the proximity sensor for at least a threshold period of time. In some implementations, the component monitor 124 may receive input from a user when the user repairs a component but does not remove or replace the component, in which case the output of the proximity sensor does not change.

The vehicle 104 may provide the vehicle sensor data 144 to the server 106 at periodic intervals such as every hour in response to a request from the server 106. The vehicle 104 may provide the vehicle sensor data 144 to the server 106 after receiving wireless power 140 from the charging pad 110, upon the user 102 turning the vehicle 104 on and/or off, and/or in response to other events. As illustrated in the example of FIG. 1 and in stage C, the vehicle 104 may provide the vehicle sensor data 144 to the server 106. The vehicle sensor data 144 may indicate that the odometer of the vehicle 104 is fifteen thousand miles, the battery 118 level is thirty percent, the battery 118 voltage is three hundred volts, the brake pedal is depressed, the throttle pedal is not depressed, the parking brake is off, the location is Elm St and Pecan St, the air conditioner is on, the cabin temperature is twenty degrees Celsius, the driver's seatbelt is engaged, the passenger's seatbelt is not engaged, and the tire pressure is thirty pounds per square inch. The vehicle sensor data 144 may also include various battery thermal parameters that indicate the temperature of various cells of the battery 118.

In some implementations, the vehicle sensor data 144 may include values over a period of time that may be the values since the vehicle 104 previously provided the vehicle sensor data 144 to the server 106. For example, the brake pedal data may indicate the position of the brake pedal each second during the hour since the vehicle 104 previously provided the vehicle sensor data 144 to the server 106. As another example, the brake pedal data may indicate that the brake pedal was depressed forty percent of the time during the hour since the vehicle 104 previously provided the vehicle sensor data 144 to the server 106. As another example, the cabin temperature data may indicate an average temperature during the hour since the vehicle 104 previously provided the vehicle sensor data 144 to the server 106.

The server 106 may receive the charger sensor data 142 and the vehicle sensor data 144 and store the sensor data 126 in a storage medium of the server 106 and/or in a storage medium accessible by the server 106. In some implementations, the server 106 may timestamp the data indicating the date and time at which the server 106 received the charger sensor data 142 and/or the vehicle sensor data 144. In some implementations, the charger sensor data 142 and/or the vehicle sensor data 144 may include timestamps that indicate the date and time that the corresponding data was collected. In some implementations, the server 106 may store identification data with the received charger sensor data 142 and/or the vehicle sensor data 144. The identification data may identify the vehicle, charger circuitry, or charging pad that provided the charger sensor data or the vehicle sensor data. In some implementations, the charger sensor data 142 and/or the vehicle sensor data 144 may include the identification data.

The server 106 may receive data related to the servicing of components of the charging pad 110, charger circuitry 112, and the vehicle 104. The server 106 may store the data related to the servicing of components in the component service data 136 that may be located in a storage medium of the server 106 and/or in a storage medium accessible by the server 106. The server 106 may timestamp the component service data 136 indicating the date and time at which the server 106 received the component service data 136. In some implementations, the component service data 136 may indicate a date and/or time of the servicing of the component. In some implementations, the server 106 may store identification data with component service data 136. The identification data may be a unique identifier that identifies the vehicle, charging pad, or charging circuitry that provided the component service data. In some implementations, the component data received from the vehicle 104, the charging pad 110, and/or the charger circuitry 112 may include identification data that identifies the vehicle, charging pad, or charging circuitry. For example, and as illustrated in stage D, the component monitor 124 of the vehicle 104 may provide component data 138 indicating that the brakes of the vehicle 104 were replaced in October 2020 and the tires were inflated to thirty-two pounds per square inch in January 2021. The server 106 may receive this component data 138 and store the component data 138 in the component service data 136.

The server 106 may include an analyzer 132. The analyzer 132 may be configured to analyze the sensor data 126 and/or the component service data 136. The analyzer 132 may identify a component of the vehicle 104, the charger circuitry 112, and/or the charging pad 110 that should be repaired or replaced. The analyzer 132 may use various sensor data analysis models and/or sensor data analysis rules to analyze the sensor data 126 and/or the component service data 136. The sensor data analysis models and sensor data analysis rules will be discussed in more detail below. Briefly, the sensor data analysis models may be configured to receive at least a portion of the sensor data 126 and/or the component service data 136. The sensor data analysis models may be configured to output data identifying a component of the vehicle 104, the charger circuitry 112, and/or the charging pad 110 that should likely be repaired or replaced. Different sensor data analysis models may be configured to analyze different types of data. For example, a first sensor data analysis model may be configured to analyze battery voltage, current, frequency, and thermal data and output data indicating whether one or more of the battery cells should be replaced. A second sensor data analysis model may be configured to analyze battery parameters, odometer data, brake pedal data, throttle pedal data, and climate control data and data indicating whether the brakes should be repaired or replaced.

The sensor data analysis rules may specify various ranges and/or thresholds for different types of sensor data 126 and/or component service data 136. Based on which side of a threshold or on which range the value of a portion of the sensor data 126 may be located, the sensor data rules may determine that a specific problem may exist with the vehicle 104, the charger circuitry 112, and/or the charging pad 110. Different sensor data rules may include ranges and thresholds for different types of data and may specify different types of problems with the vehicle 104, the charger circuitry 112, and/or the charging pad 110. In some implementations, the sensor data rules may identify more than one problem with the vehicle 104, the charger circuitry 112, and/or the charging pad 110.

The analyzer 132 may include a sensor data selector 128 and a component selector 130. The component selector 130 may be configured to select a component for the analyzer 132 to determine whether the component should likely be repaired or replaced. In instances where the sensor data analysis models and/or sensor data analysis rules are configured to determine whether a particular component should likely be repaired or replaced, the component selector 130 may select the component for analysis. In some implementations, the component selector 130 may select components in sequential order. For example, the component selector may analyze the battery, brakes, tires, etc. in a specific order. The order may be determined by a user, component life expectancy, previous repair or replacement dates, and/or any other similar factor. The order may be adjusted after a part is repaired and/or replaced. The order adjustment may be based on the expected lifespan of the repaired or replaced component. In some implementations, the component selector 130 may select components in response to a request from a user. For example, the user may request information on whether a specific component should be repaired and/or replaced.

In some implementations, the component selector 130 may select a component for analysis based on a portion of the sensor data satisfying a threshold. For example, if the temperature of a battery cell is outside of a temperature range, then the component selector 130 may select the battery 118 for analysis. In some implementations, the component selector 130 may select a component for analysis based on an expected lifespan expiring. For example, if the tires have an expected lifespan of fifty thousand miles or five years, then the component selector 130 may select the tires for analysis when the miles driven or time period of the tire usage is within a threshold of the expected lifespan.

The component selector 130 may also be configured to select the appropriate sensor data analysis model and/or sensor data analysis rule that is configured to analyze the selected component. In some instances, the sensor data analysis models may be configured to output data indicating whether a certain component should be repaired or replaced. For example, a first sensor data analysis model may be configured to determine whether the tires should be repaired or replaced. A second sensor data analysis model may be configured to determine whether the receiving pad should be repaired or replaced. The component selector 130 may select the sensor data analysis model that is configured to determine whether the receiving pad should be repaired or replaced in response to selecting the receiving pad for analysis.

The sensor data selector 128 may be configured to select the appropriate sensor data based on the selected sensor data analysis model and/or sensor data analysis rule. In some instances, different sensor data analysis models and/or sensor data analysis rules may be configured to analyze different types of data. For example, a sensor data analysis rule that is configured to determine whether an air conditioning compressor should be repaired and/or replaced may be configured to analyze data that includes the air conditioning compressor usage, temperature data, humidity data, location data, battery voltage data, battery capacity data, battery current data, battery frequency data, battery thermal data, battery service data, and air conditioning compressor service data. In this case, the sensor data selector 128 may select this data from the sensor data 126 and the component service data 136 in response to the component selector 130 selecting the air conditioning compressor for analysis.

In some implementations, the sensor data analysis models and/or sensor data analysis rules may be configured to identify multiple components for repair and replacement. In this case, a sensor data analysis model and/or sensor data analysis rule may not be configured to determine whether a specific component should be repaired or replaced. For example, a sensor data analysis model and/or sensor data analysis rule may be configured to identify whether a battery cell, brakes, tires, air conditioner, electric motor, and headlights should be repaired and/or replaced. As another example, a sensor data analysis model and/or sensor data analysis rule may be configured to identify any component of a specific vehicle model that should be repaired and/or replaced.

In the case where the sensor data analysis models and/or sensor data analysis rules are configured to identify multiple components for repair and replacement, it may not be necessary for the component selector 130 to select a component for analysis. The sensor data selector 128 may select the sensor data 126 and/or component service data 136 based on the available sensor data analysis models and/or sensor data analysis rules.

In the example of FIG. 1 and in stage E, the component selector 130 may select the battery 118 for analysis. The component selector 130 may select the battery 118 for analysis and select a sensor data analysis model that is configured to determine whether the battery 118 should be repaired or replaced. The sensor data selector 128 may select the sensor data 126 and component service data 136 that the selected sensor data analysis model is configured to analyze. That data may include battery voltage data, battery capacity data, battery current data, battery frequency data, battery thermal data, battery service data, air conditioning usage, audio system usage, headlight usage, location data, and battery service data. The sensor data analysis model may output data indicating that, for example, battery cell number three should be replaced.

The server 106 may be configured to output data indicating whether a component of the vehicle 104, the charger circuitry 112, and/or the charging pad 110 should be repaired or replaced. The server 106 may output a recommendation 152 for a user to comply with. The server 106 may transmit the recommendation 152 to different devices depending on the recommendation 152. For example, a recommendation 152 to replace the coil of the charging pad 110 may be transmitted to the charging circuitry 112. The charging circuitry 112 may output the recommendation 152 on a display that is connected to the charging circuitry 112. The display may be included in a housing that includes the charging circuitry 112. The recommendation 152 to replace the coil of the charging pad 110 may be transmitted to a computing device that manages and monitors the charging pad 110, the charger circuitry 112, and other chargers, output to a display of the server 106, and/or output to a computing device of a user, such as a mobile device. As another example, a recommendation to replace the brakes of the vehicle 104 may be transmitted to a computing device of the user 102, such as a mobile device, output to a display of the server 106, output to the vehicle 104, and/or output to a device that manages and monitors the vehicle 104 and other vehicles. In the case where the vehicle 104 receives the recommendation 152, the vehicle 104 may output the recommendation 152 to a display of the vehicle 104.

In some implementations, the server 106 may be able to automatically implement the recommendation 152 if there are devices that are configured to automatically replace and/or repair components of the vehicle 104, charging circuitry 112, or the charging pad 110. For example, there may be a device that is configured to add or remove air from the tires of the vehicle 104. In this case, that device may receive the recommendation 152 for airing up the tires, automatically add air to the tires when the vehicle 104 is near the device, and report back to the server 106 once the device adds air to the tires. If the recommendation 152 involves updating software, activating hardware, and/or deactivating hardware, then the server 106 may be able to perform these actions automatically. These actions may include altering switches in the charger circuitry 112, altering switches in the receiver circuitry 123, and/or adjusting the wattage of power provided to the vehicle 104 from the charging pad 110 or other charging pads. These actions may occur in response to the server 106 transmitting the recommendation 152 to the vehicle 104 or the charger circuitry 112 for automatic implementation.

In the example of FIG. 1 and in stage G, the analyzer 132 determines that battery cell number three should be replaced. The server 106 generates the recommendation 152 indicating that the battery cell number three should be replaced. The server 106 determines that there are no devices available that are configured to automatically replace a battery cell. In this case, the server 106 transmits the recommendation 152 to the vehicle 104. The vehicle 104 may receive the recommendation 152 and output the recommendation 152 on a display of the vehicle 104. In some implementations, the server 106 may output the recommendation 152 to a computing device of the user 102.

The vehicle 104 may receive the recommendation 152 and output the recommendation 152 to a display of the vehicle 104. The user 102 may view the recommendation 152 and decide whether to comply with or reject the recommendation 152. If the user 102 decides to reject the recommendation 152, then the user 102 may indicate that decision to the vehicle 104 by selecting a reject option on the display of the vehicle 104 or by ignoring the recommendation 152 for a threshold period of time, such as two weeks. If the user 102 decides to comply with the recommendation 152, then the user 102 may comply with the recommendation 152 and select a comply option on the display of the vehicle 104.

The vehicle 104 may generate a recommendation response 150 that indicates whether the user 102 agreed to comply with the recommendation 152. The recommendation response 150 may indicate that the user 102 selected the comply option, the reject option, or did not respond within a threshold period of time. In some implementations, the recommendation response 150 may also include data from one or more proximity sensors of the vehicle 104. The proximity sensors may indicate whether a component was removed for a period of time, which may indicate a replacement. In some implementations, the recommendation 152 may indicate to replace a component, and the user 102 may not actively select the comply option. The user 102 may replace the component anyway. In this case, the proximity sensors may detect the component was removed for a period of time, and the vehicle 104 may generate the recommendation response 150 indicating compliance with the recommendation 152.

In the example of FIG. 1 and in stage G, the user 102 may select the comply option for the recommendation 152 indicating to replace battery cell number three. A proximity sensor may also detect that battery cell number three was removed for a period of time. The vehicle 104 may generate the recommendation response 150 indicating that the battery cell number three was replaced and transmit the recommendation response 150 to the server 106.

The server 106 may include a recommendation monitor 134 that is configured to monitor the outstanding recommendations 152. The recommendation monitor 134 may store data in the component service data 136 indicating when components have been repaired and/or replaced. The recommendation monitor 134 may also be configured to determine when to withdraw a recommendation in the case of inaction by the user. For example, the recommendation monitor 134 may withdraw a recommendation to replace an interior cabin light if the user 102 does not comply with the recommendation within two weeks. The recommendation monitor 134 may determine to maintain certain recommendations for components that may be related to safety issues. For example, the recommendation monitor 134 may not withdraw recommendations to replace and/or repair brakes.

The server 106 may continue to receive sensor data 126 and component service data 136 from the charging pad 110, charging circuitry 112, and the vehicle 104. The server 106 may analyze the sensor data 126 and component service data 136 and generate additional recommendations for repairing and/or replacing components of the charging pad 110, charging circuitry 112, and the vehicle 104.

In some implementations, the charger sensor data 142 may not be directly provided to the server 106 from the charger sensors 114 and the vehicle sensor data 144 may not be directly provided to the server 106 from the vehicle 104. The charger sensors 114 may provide the charger sensor data 142 to the vehicle 104. The vehicle 104 may provide the charger sensor data 142 and the vehicle sensor data 144 to the server 106. Additionally, or alternatively, the vehicle 104 may provide the vehicle sensor data 144 to the charger circuitry 112 and/or the charger sensors 114. The charger circuitry 112 and/or the charger sensors 114 may provide the charger sensor data 142 and the vehicle sensor data 144 to the server 106. In some implementations, the charger sensors 114 and/or the vehicle 104 may provide the charger sensor data 142 and/or the vehicle sensor data 144 to an intermediate device. The intermediate device may provide the charger sensor data 142 and/or the vehicle sensor data 144 to the server 106. The intermediate device may be any type of device that is capable of communicating with the charger sensors 114, vehicle 104, and the server 106. For example, the intermediate device may be a mobile phone, tablet, smart watch, laptop computer, desktop computer, and/or any other similar device.

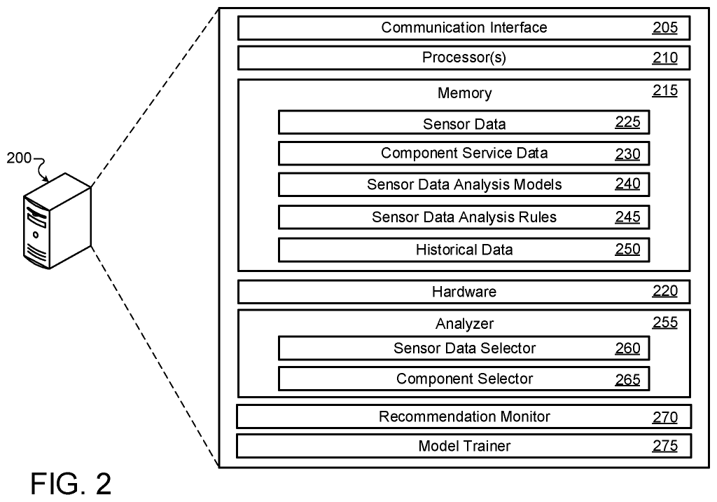

FIG. 2 illustrates an example server that is configured to identify maintenance issues of a wireless power transfer system and/or an electric vehicle. The server 200 may be any type of computing device that is configured to communicate with other computing devices. The server 200 may communicate with other computing devices using a wide area network, a local area network, the internet, a wired connection, a wireless connection, and/or any other type of network or connection. The wireless connections may include Wi-Fi, short-range radio, infrared, and/or any other wireless connection. The server 200 may be similar to the server 106 of FIG. 1. Some of the components of the server 200 may be implemented in a single computing device or distributed over multiple computing devices. Some of the components may be in the form of virtual machines or software containers that are hosted in a cloud in communication with disaggregated storage devices.

The server 200 may include a communication interface 205, one or more processors 210, memory 215, and hardware 220. The communication interface 205 may include communication components that enable the server 200 to transmit data and receive data from other devices and networks. In some implementations, the communication interface 205 may be configured to communicate over a wide area network, a local area network, the internet, a wired connection, a wireless connection, and/or any other type of network or connection. The wireless connections may include Wi-Fi, short-range radio, infrared, and/or any other wireless connection.

The hardware 220 may include additional user interface, data communication, or data storage hardware. For example, the user interfaces may include a data output device (e.g., visual display, audio speakers), and one or more data input devices. The data input devices may include, but are not limited to, combinations of one or more of keypads, keyboards, mouse devices, touch screens that accept gestures, microphones, voice or speech recognition devices, and any other suitable devices.

The memory 215 may be implemented using computer-readable media, such as non-transitory computer-readable storage media. The memory 215 may include a plurality of computer-executable components that are executable by the one or more processors 210 to perform a plurality of actions. Computer-readable media includes, at least, two types of computer-readable media, namely computer storage media and communications media. Computer storage media includes volatile and non-volatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD), high-definition multimedia/data storage disks, or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanism.

The memory 215 may store sensor data 225. The sensor data 225 may be similar to the sensor data 126 of FIG. 1. The communication interface 205 may receive charger sensor data from various charger sensors and vehicle sensor data from various vehicles. The processor(s) 210 may store the received sensor data in the sensor data 225. In some implementations, the processor(s) 210 may timestamp the received data to indicate when the server 200 received the sensor data 225. In some implementations, the received data may already be timestamped by the collecting device to indicate the date and time when the data was collected. In some implementations, the processor(s) 210 may store identification data that may identify the source of the received sensor data, such as data identifying the particular vehicle and/or vehicle model. In some implementations, the received data may already include identification data.

The memory 215 may store the component service data 230. The component service data 230 may be similar to the component service data 136 of FIG. 1. The communication interface 205 may receive component service data and/or recommendation responses from various vehicles and chargers that may include a charging pad and charger circuitry. The processor(s) 210 may store the received component service data in the component service data 230. The processors(s) 210 may determine whether a recommendation response includes any component service data. If so, then the processor(s) 210 may store the component service data from the recommendation response in the component service data 230. The component service data 230 may include identification data that identifies the corresponding vehicle or chargers.

The one or more processors 210 may implement the analyzer 255. The analyzer 255 may be similar to the analyzer 132 of FIG. 1. Like the analyzer 132, the analyzer 255 may be configured to analyze the sensor data 126 using the component selector 265 and the sensor data selector 260. The component selector 265 may be similar to the component selector 130 of FIG. 1. The sensor data selector 260 may be similar to the sensor data selector 128 of FIG. 1. The component selector 265 may be configured to identify the component of a vehicle or charger for analyzing. The component selector 265 may also select from the sensor data analysis models 240 and/or the sensor data analysis rules 245 and select a model and/or rule to analyze the selected component. The sensor data selector 260 may select from the sensor data 225 and access the sensor data that the selected model and/or rule is configured to receive. The analyzer 255 may process the selected sensor data using the selecting model and/or rule and determine whether a component of a vehicle or charger should be repaired or replaced.

The one or more processors 210 may implement a model trainer 275. The model trainer 275 may be configured to train the sensor data analysis models 240 using machine learning and the historical data 250 and generate the sensor data analysis rules 245 using the historical data 250. The memory 215 may store the historical data 250. The historical data 250 may store data similar to the sensor data 225 and/or component service data 230 that is related to various vehicles, charger circuitry, and charging pads. Portions of the historical data 250 may include labels that identify a component and whether that component needed to be repaired and/or replaced. The labels may originate from users who observe that components should be repaired and/or replaced. The processors(s) 210 may add the labels to the historical data 250 to cover a period of time before the repair and/or replacement. The period of time may correspond to the period of time since the component was repaired and/or replaced or a fixed period of time depending on the component. For example, the period of time for tires may be a week, and the period of time for battery cells may be two weeks. In some implementations, each label may include a time period or mileage when the component will fail. For example, a label may indicate that a battery cell will be replaced in two weeks or that a coil of the receiving pad will be replaced in three days.

The sensor data 225 may contain various types of data collected from vehicles and chargers. The sensor data received from a vehicle may include location data, accessory usage data, brake pedal usage data, throttle usage data, steering wheel position data, speed data, passenger load data, battery level data, interior temperature data, motor temperature, receiving pad temperature, battery temperature data for the entire battery and/or for each battery cell, exterior temperature data, battery voltage, volumetric heat generation of the battery, conduction-convection parameter of the battery, Reynolds number of the battery, an aspect ratio of the battery, battery percentage remaining, energy recovered from a brake energy recoverer (e.g., a regenerative braking system), data identifying a driver, data identifying a regenerative braking profile, battery capacity, wireless power received, energy stored in the battery, previous charging locations, humidity data inside the vehicle, humidity data outside the vehicle, humidity data in or near any portion of the receiving pad, motor, or battery, water presence data inside the vehicle, water presence data outside the vehicle, water presence data in or near any portion of the motor, receiving pad, or battery, and/or any other similar data. The accessories may include headlights, air conditioner, heater, interior lights, defrost, audio players, navigation equipment, door operation, public announcement system, and/or any other similar types of accessories. The sensor data received from a charger sensor may include location data, data identifying charged vehicles, wireless power provided, power received from a power supply, temperature data in and/or near any portion of the charger, humidity data in and/or near any portion of the charger, water presence data in and/or near any portion of the charger, pressure data indicating pressure received from any exterior object such as a vehicle, and/or any other similar information. Any of the sensor data received from a vehicle and/or the charger sensors may include timestamps that indicate a date and time during which the corresponding sensor detected the data.

The component service data 230 may include data related to the dates when a component of a vehicle or charger was repaired or replaced. If a component has not been repaired or replaced, then the corresponding date for that component may be the date of manufacture of the vehicle or charger. The component service data 230 may include information related to the type of repair or other servicing. For example, the tires may indicate a date of replacement and a date of the previous inflation along with the inflated pressure. The component service data 230 may also include data related to an expected lifespan of each component.

The model trainer 275 may group the historical data 250 into data samples. Each data sample may represent the state of a vehicle or charger at a point in time. A data sample may include the sensor data collected from the vehicle or charger at that point in time and the component service data for that vehicle or charger at that point in time. Each data sample may also include a data label identifying one or more components that will need repair or replacement within a threshold period of time. The threshold period of time may depend on the component. For example, if the component is a battery cell, then the threshold period of time may be two weeks. If the component is a tire, then the threshold period of time may be one week. If the component is a bulb, then the threshold period of time may be one day.

The model trainer 275 may group the data samples into various training groups. The model trainer 275 may use the training groups to train models using machine learning. The resulting models may be configured to receive sensor data and/or component service data and output data indicating whether one or more components should be repaired or replaced. Some models may be configured to receive sensor data and/or component service data and output data related to a specific component. Other models may be configured to receive sensor data and/or component service data and output data indicating one or more of a group of components and whether each component should be repaired or replaced.

The model trainer 275 may include different labels for each data sample depending on the intended output of the resulting model. For example, if the intended output of the model is to determine whether a battery cell should be repaired or replaced, then the model trainer 275 may include labels related to the battery. If the intended output of the model is to determine whether any portion of the motor or receiving pad should be repaired or replaced, then the model trainer 275 may include labels related to the motor and receiving pad. If the intended output of the model is any component of the charger, then the model trainer 275 may include labels related to each component of the charger. In some implementations, each label may include a time period or mileage when the component will fail. For example, a label may indicate that a battery cell will be replaced in three hundred miles or that a coil of the receiving pad will be replaced after one week. In this case, the output may indicate a time period or mileage before the component is likely to need repair or replacement.

Each data sample may be cumulative up to the previous repair or replacement of a component or up to a threshold period of time. The threshold period of time may be based on the component. In some implementations, the threshold period of time may vary depending on the model of the vehicle or charger and an expected lifespan of the component in that vehicle model or charger model. The threshold period of time may vary depending on the location vehicle or charger. In this way, the time range for this group of data samples may start at the beginning of the threshold period of time or the time of the previous repair or replacement and end at the subsequent repair or replacement. The start of the time range may be time equals zero. A first data sample may include the sensor data and component service data collected at this time and any corresponding labels. A second data sample may represent time equals one and may include the sensor data and component service data of the first data sample and the additional sensor data collected at time equals one. The second data sample may also include component service data collected at time equals one if that data is different than the component service data from the first data sample. A third data sample may represent time equals two and may include sensor data of the first data sample, the second data sample, and the additional sensor data collected at time equals two. If component service data is different, then that is included also. This pattern may continue until the end of time period when a component was repaired or replaced.

The model trainer 275 may train various models using machine learning and the training groups. The resulting models may be configured to receive data and output data based on the sensor data and labels included in the training group. For example, a first training group may include vehicle data identifying brake usage, battery percentage, battery voltage, battery thermal parameters, throttle usage, speed, odometer, location, and a label indicating that a battery cell will be replaced in a certain number of miles. The resulting model trained from the first training group may be configured to receive data identifying brake usage, battery percentage, battery voltage, battery thermal parameters, throttle usage, speed, odometer, and location and output data indicating that the battery cell will not likely need to be replaced within a certain number of miles or that the battery cell will likely need to be replaced within a certain number of miles. In the case of the model outputting data indicating that the battery cell will not likely need to be replaced within a certain number of miles, this number of miles may be based on the training data. If the training data covers one thousand miles, then this certain number of miles will be one thousand miles. The number of miles identified in an output indicating that the battery cell will likely need to be replaced within a certain number of miles will be less than one thousand miles.

A second training group may include charger data identifying power received from an external power supply, power output by the charging pad, internal water presence, internal and external humidity, and internal and external temperature, and a label indicating that the coil will be replaced in a certain time period and a label indicating that the internal power supply will be replaced in a certain period of time. The resulting model trained from the second training group may be configured to receive charger data identifying power received from an external power supply, power output by the charging pad, internal water presence, internal and external humidity, and internal and external temperature. The resulting model may output data indicating that the coil will likely not need to be replaced in a certain period of time or that the coil will likely need to be replaced in a certain period of time and data indicating that the internal power supply will likely not need to be replaced in a certain period of time or that the internal power supply will likely need to be replaced in a certain period of time. In the case of the model outputting data indicating that the coil and/or internal power supply will likely not need to be replaced in a certain period of time, this period of time may be based on the training data. If the training data covers two weeks, then this period of time will be two weeks. The period of time identified in an output indicating that the coil and/or internal power supply will likely need to be replaced will be less than two weeks.

Each model may be configured to receive and analyze the sensor data 225 and/or component service data 230 in a cumulative manner. In this way, a model may output that a component will likely not need repair or replacement in a period of time or distance after receiving sensor data and/or component service data collected at a single point in time. As the server 200 continues to receive sensor data and/or component service data, the analyzer 255 may continue to provide the additional sensor data and/or component data to the model. As the model receives additional sensor data and/or component service data, the output of the model may change. For example, the model may receive, from a charger, data identifying power received from an external power supply, power output by the charging pad, internal water presence, internal and external humidity, and internal and external temperature collected at a first point in time. The model may output data indicating that the coil and the internal power supply likely do not need to be replaced within two weeks. The model may continue to receive additional data identifying power received from an external power supply, power output by the charging pad, internal water presence, internal and external humidity, and internal and external temperature at subsequent points in time. The output of the model may change with the additional data and may indicate that the coil and the internal power supply likely need to be replaced within a period of time. The period of time indicated in the output may increase, decrease, or remain the same as the model receives additional data.

The model trainer 275 may analyze the historical data 250 to identify patterns for generating the sensor data analysis rules 245. The model trainer 275 may identify sensor data patterns that corresponds to different component repair and/or replacement incidents. These sensor data patterns may include various ranges, thresholds, and/or other similar comparison mechanisms to analyze the sensor data 225 and/or the component service data 230. For example, the model trainer 275 may analyze the historical data 250 and determine that a coil of the charger will likely need replacement within a week if the humidity remains above sixty percent for a two-week period. In this case, the model trainer 275 may generate a rule that compares the humidity in the charging pad to a sixty percent threshold. The rule may indicate that if the humidity remains above that threshold for two weeks, then the coil of the charging pad will likely need replacement in one week. As another example, the model trainer 275 may analyze the historical data and determine that a battery cell will likely need replacement in three days if the voltage drops below ten percent of the original voltage and the current drops below ten percent of the original current for more than five minutes while motor is driving the wheels. In this case, the model trainer 275 may generate a rule that compares the voltage and current of a battery cell to a ten percent threshold of the original voltage and current for the battery cell. The rule may indicate that is the voltage and current of a battery cell drops below a ten percent threshold of the original current and voltage for five minutes while motor is driving the wheels, then the battery cell will likely need to be replaced in three days.

In some implementations, the sensor data analysis rules 245 may include user-specified rules. These rules maybe ones that indicate patterns, thresholds, and/or ranges to identify in the sensor data 225 and/or the component service data 230. If the sensor data 225 matches any of those patterns, threshold, and/or ranges, then the rules may specify that a component will likely need to be repaired or replaced in a specified period of time. For example, a user-specified rule may indicate that if the temperature of a battery cell is at least ten degrees warmer than another battery cell, then that battery cell should be replaced within one week. Another user-specified rule may indicate that if the vehicle has driven thirty thousand miles, then the brakes should be replaced within two weeks.

The one or more processors 210 may implement the recommendation monitor 270. The recommendation monitor 270 may be similar to the recommendation monitor 134 of FIG. 1. The recommendation monitor 270 may be configured to monitor whether a recommendation output by the analyzer 255 is accepted, rejected, or ignored. Based on that data, the recommendation monitor 270 may update the component service data 230.

In some implementations, the historical data 250 may continue to update. This may be the result of receiving additional sensor data and/or component service data and corresponding labels. This may also be a result of the recommendation monitor 270 updating the component service data 230, a user indicating that a component has been repaired or replaced, and/or a proximity detector indicating that a component has been replaced. With the indication of completion of a component being repaired or replaced, the processor(s) 210 may update the historical data 250 with the additional sensor data and/or component service data and one or more labels indicating that a component has been repaired or replaced. As additional historical data 250 is added, the model trainer 275 may continue to generate additional data samples and retrain the sensor data analysis models 240, generate additional sensor data analysis rules 245, and/or update the patterns, thresholds, and/or ranges of the sensor data analysis rules 245.

FIG. 3 illustrates an example vehicle 300 that is configured to identify maintenance issues of an electric vehicle. The vehicle 300 any type of electric vehicle that is capable of communicating with other vehicles and/or computing devices. The vehicle 300 may communicate with other vehicles and/or computing devices using a wide area network, a local area network, the internet, a wired connection, a wireless connection, and/or any other type of network or connection. The wireless connections may include Wi-Fi, short-range radio, infrared, and/or any other wireless connection. The vehicle 300 may be similar to the vehicle 104 of FIG. 1. Some of the components of the vehicle 300 may be implemented in a single vehicle or distributed over the vehicle 300 and various other devices that may communicate with the vehicle 300 but may not be included in the vehicle 300 as it travels. Some of the components may be in the form of virtual machines or software containers that are hosted in a cloud in communication with disaggregated storage devices.

The vehicle 300 may include a communication interface 305, one or more processors 310, memory 315, and hardware 320. The communication interface 305 may include communication components that enable the vehicle 300 to transmit data and receive data from other devices and networks. In some implementations, the communication interface 305 may be configured to communicate over a wide area network, a local area network, the internet, a wired connection, a wireless connection, and/or any other type of network or connection. The wireless connections may include Wi-Fi, short-range radio, infrared, and/or any other wireless connection.

The memory 315 may be implemented using computer-readable media, such as computer storage media. Computer-readable media includes, at least, two types of computer-readable media, namely computer storage media and communications media. Computer storage media includes volatile and non-volatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD), high-definition multimedia/data storage disks, or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanism.

The memory 315 may store sensor data 325. The sensor data 325 may be similar to the sensor data 126 of FIG. 1 and the sensor data 225 of FIG. 2. The sensor data 325 may store data related to the vehicle 300. The vehicle sensors 375 may generate sensor data, and the processor(s) 310 may store that data in the sensor data 225. In some implementations, the processor(s) 310 may timestamp the received sensor data to indicate when the sensors 375 generated the sensor data 325. In some implementations, the sensor data may already be timestamped by the corresponding sensor upon collection. In some implementations, the sensor data 325 may also include charger sensor data received from charger sensors with which the vehicle 300 interacted. For example, the vehicle 300 may receive wireless power from a charging pad. The charging pad or charger circuitry may also communicate with the vehicle and provide charger sensor data that the vehicle 300 may store in the sensor data 325.

The memory may store the component service data 330. The component service data 330 may be similar to the component service data 136 of FIG. 1 and the component service data 230 of FIG. 2. The component service data 330 may store data related to components of the vehicle 300. The component service data 330 may store data indicating when the various components of the vehicle 300 were repaired or replaced. In some implementations, the component service data 330 may include data received from users indicating that component has been repaired or replaced. In some implementations, the component service data 330 may include data received from proximity detectors that may indicate when a component has been removed.

The hardware 320 may include additional user interface, data communication, or data storage hardware. For example, the user interfaces may include a data output device (e.g., visual display, audio speakers), and one or more data input devices. The data input devices may include, but are not limited to, combinations of one or more of keypads, keyboards, mouse devices, touch screens that accept gestures, microphones, voice or speech recognition devices, and any other suitable devices.

The hardware 320 may also include vehicle sensors 375, and a receiving pad 380, a battery 385. The vehicle sensors 375 may be similar to the vehicle sensors 116 of FIG. 1. The vehicle sensors 375 may be configured to collect data related to the characteristics of the vehicle 300, the various components of the vehicle 300, and the environment in and around the vehicle 300. The receiving pad 380 may be similar to the receiving pad 122 of FIG. 1. The receiving pad 380 may be configured to receive wireless power from a charging pad. The battery 385 may be similar to the battery 118 of FIG. 1. The battery 385 may store and provide power to the vehicle 300.

The one or more processors 310 may implement the analyzer 355. The analyzer 355 may be similar to the analyzer 132 of FIG. 1 and the analyzer 255 of FIG. 2. Like the analyzer 132 and the analyzer 255, the analyzer 355 may be configured to analyze the sensor data 325 and/or the component service data 330 using the sensor data selector 360 and the component selector 365. The sensor data selector 360 may be similar to the sensor data selector 128 of FIG. 1 and the sensor data selector 260 of FIG. 2. The component selector 365 may be similar to the component selector 130 of FIG. 1 and the component selector 265 of FIG. 2. The component selector 365 may be configured to identify one or more components of the vehicle 300 to determine whether the components should be repaired or replaced. The component selector 365 may select the components in sequential order, an expected lifespan order, a user-specified order, and/or any other similar order. The component selector 365 may select one or more of the sensor data analysis models 340 and/or sensor data analysis rules 345 to determine whether the selected component should be repaired. The sensor data selector 360 may select the sensor data from the sensor data 325 and the component service data from the component service data 330 for analysis based on the inputs to the selected sensor data analysis model and/or the selected sensor data analysis rule.

The memory 315 may store the sensor data analysis models 340 and the sensor data analysis rules 345. The sensor data analysis models 340 may be similar to the sensor data analysis models 240 of FIG. 2. The sensor data analysis rules 345 may be similar to the sensor data analysis rules 245 of FIG. 2. The sensor data selector 360 and the component selector 365 may use the sensor data analysis models 340 and the sensor data analysis rules 345 to analyze the sensor data 325 and/or the component service data 330 in a similar manner to the sensor data selector 260 and the component selector 265 using the sensor data analysis models 240 and the sensor data analysis rules 245 to analyze the sensor data 225 and/or the component service data 230.

The vehicle 300 may receive the sensor data analysis models 340 and the sensor data analysis rules 345 from a server such as the server 106 of FIG. 1 and/or the server 200 of FIG. 2. The server 106 and/or the server 200 may train and generate the sensor data analysis models 340 and the sensor data analysis rules 345. The server 106 and/or the server 200 may train and generate the sensor data analysis models 340 and the sensor data analysis rules 345 in part using the sensor data 325 that the vehicle 300 provides to the server 106 and/or the server 200. In some implementations, the server 106 and/or the server 200 may train and generate updated sensor data analysis models and sensor data analysis rules. In this case, the server 106 and/or the server 200 may provide the updated sensor data analysis models and sensor data analysis rules. The analyzer 355 may then use the updated sensor data analysis models 340 and the sensor data analysis rules 345.

The one or more processors 310 may implement the recommendation monitor 370. The recommendation monitor 370 may be similar to the recommendation monitor 134 of FIG. 1 and/or the recommendation monitor 270 of FIG. 2. The recommendation monitor 370 may be configured to monitor whether a recommendation output by the analyzer 355 is accepted, rejected, or ignored. Based on that data, the recommendation monitor 370 may update the component service data 330.

The one or more processors 310 may implement the component monitor 390. The component monitor 390 may be similar to the component monitor 124 of FIG. 1. The component monitor 390 may be configured to determine whether a component of the vehicle 300 has been removed. The component monitor 390 may communicate with various proximity sensors. Each proximity sensors may be positioned so that a proximity sensor may indicate whether a certain component is in the vicinity of the proximity sensor. Based on the data from the proximity sensor, the component monitor 390 may determine whether the component was replaced. If so, then the component monitor 390 may update the component service data 330 with data identifying the component and the date of replacement.

Integrating the above components into the vehicle 300 may allow the vehicle 300 to identify maintenance issues with the vehicle 300, charger circuitry, and/or charging pad. In instances where the maintenance issue is something that can be automatically addressed, the vehicle 300 may automatically perform the action to address the maintenance issue without user intervention. These actions may include those that include software updates, adjustments to hardware that can be remotely controlled, and/or any similar changes. The hardware or software may be part of the vehicle 300 or part of the charger circuitry and/or charging pad.

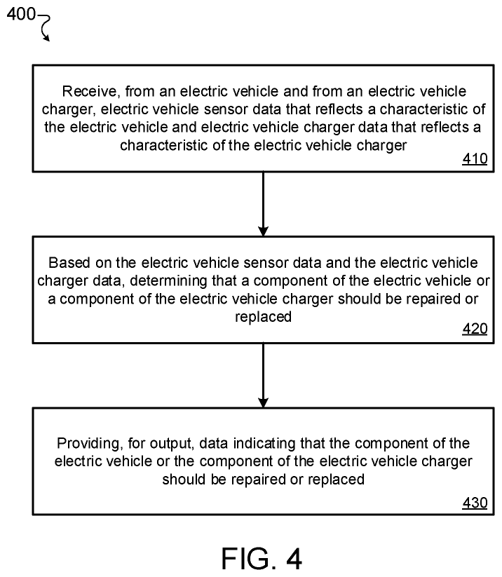

FIG. 4 is a flowchart of an example process 400 for identifying maintenance issues of a wireless power transfer system and/or an electric vehicle 104. In general, the process 400 analyzes sensor data received from an electric vehicle 104 and/or an electrical vehicle charger. The electrical vehicle charger may include charger sensors 114, a charging pad 110, charger circuitry 112, and/or the power grid 111. Based on analyzing the sensor data, the process 400 determines whether a component of the electric vehicle 104 and/or a charger should be replaced. If so, then the process 400 may output a recommendation to replace the component or initiate a procedure to automatically replace the component. The process 400 will be described as being performed by the server 106 of FIG. 1 and will include references to components of the FIG. 1. In some implementations, the process 400 may be performed by the server 200 of FIG. 2 and/or the vehicle 300 of FIG. 3.

The server 106 receives, from an electric vehicle 104 and from an electric vehicle charger, electric vehicle sensor data 144 that reflects a characteristic of the electric vehicle 104 and electric vehicle charger data 142 that reflects a characteristic of the electric vehicle charger (410). In some implementations, the electric vehicle 104 includes a receiving pad 122 that is configured to receive power wirelessly from a charging pad 110 of the electric vehicle charger.

Based on the electric vehicle sensor data 144 and the electric vehicle charger data 142, the server 106 determines that a component of the electric vehicle 104 or a component of the electric vehicle charger should be repaired or replaced (420). In some implementations, the server 106 may access component service data 136 that indicates a service date of the component. The service date may indicate the date when the component was previously repaired or replaced. If the component has not previously been repaired or replaced, then the service date may indicate the date of manufacture of the vehicle 104 or charger. The server 106 may determine whether the component should be repaired or replaced based further on the component service data 136. In some implementations, the server 106 may access data that indicates an expected lifespan of the component. The server may determine whether the component should be repaired or replace based further on the expected lifespan of the component.

In some implementations, the server 106 may provide the electric vehicle charger sensor data 142 and/or the electric vehicle sensor data 144 to a model that is configured to output data indicating whether the component should be repaired or replaced. The server 106 may have trained the model using machine learning and historical data. The historical data may include previously collected electric vehicle charger sensor data and/or electric vehicle sensor data and labels that indicated what components were repaired or replaced. In some implementations, the server 106 may determine a time period within which the component should be repaired or replaced. The time period may indicate the expected remaining lifespan of the component.

The server 106 provides, for output, data indicating that the component of the electric vehicle 104 or the component of the electric vehicle charger should be repaired or replaced (430). In some implementations, the server 106 may provide, for output, data indicating the time period within which the component should be repaired or replaced. In some implementations, the server 106 may receive data indicating that the component has been repaired or replaced. In this case, the server 106 may retrain the model with the electric vehicle charger sensor data and/or electric vehicle sensor data including a label indicating that the component was repaired or replaced.

Although a few implementations have been described in detail above, other modifications are possible. In addition, the logic flows depicted in the figures do not require the particular order shown, or sequential order, to achieve desirable results. In addition, other acts/actions may be provided, or acts/actions may be eliminated, from the described flows, and other components may be added to, or removed from, the described systems. Accordingly, other implementations are within the scope of the following claims.

What is claimed is:

1. A computer-implemented method, comprising:
receiving, from an electric vehicle, from an electric vehicle charger, and by a computing device, electric vehicle sensor data that reflects a characteristic of the electric vehicle and electric vehicle charger data that reflects a characteristic of the electric vehicle charger;
based on the electric vehicle sensor data and the electric vehicle charger data, determining, by the computing device, that a component of the electric vehicle or a component of the electric vehicle charger should be repaired or replaced; and
providing, for output by the computing device, data indicating that the component of the electric vehicle or the component of the electric vehicle charger should be repaired or replaced.

2. The computer-implemented method of claim 1, wherein determining that the component of the electric vehicle or the component of the electric vehicle charger should be repaired or replaced comprises:
providing, as an input to a model, the electric vehicle sensor data and the electric vehicle charger data; and
receiving, from the model, data indicating that the component of the electric vehicle or the component of the electric vehicle charger should be repaired or replaced.

3. The computer-implemented method of claim 2, comprising:
training, using machine learning and historical data that includes previous electric vehicle sensor data, previous electric vehicle charger data, and previous data indicating a repair or replacement of a component of the electric vehicle or a component of the electric vehicle charger, the model.

4. The computer-implemented method of claim 2, comprising:
receiving, by the computing device, data indicating completion of repair or replacement of the component of the electric vehicle or the component of the electric vehicle charger; and
based on (i) the data indicating completion of repair or replacement of the component of the electric vehicle or the component of the electric vehicle charger and (ii) the electric vehicle sensor data and the electric vehicle charger data, updating, using machine learning, the model.

5. The computer-implemented method of claim 1, comprising:
based on the electric vehicle sensor data and the electric vehicle charger data, determining, by the computing device, a time period when the component of the electric vehicle or the component of the electric vehicle charger should be repaired or replaced; and
providing, for output by the computing device, data indicating the time period when the component of the electric vehicle or the component of the electric vehicle charger should be repaired or replaced.

6. The computer-implemented method of claim 1, wherein the electric vehicle includes a receiving pad that is configured to receive power wirelessly from a charging pad of the electric vehicle charger.

7. The computer-implemented method of claim 1, comprising:
accessing, by the computing device, a service date of the component of the electric vehicle that indicates a previous repair or replacement of the component of the electric vehicle or a service date of the component of the electric vehicle charger that indicates a previous repair or replacement of the component of the electric vehicle charger,
wherein determining that the component of the electric vehicle or the component of the electric vehicle charger should be repaired or replaced is further based on the service date of the component of the electric vehicle or the service date of the component of the electric vehicle charger.

8. The computer-implemented method of claim 1, comprising:
accessing, by the computing device, an expected lifespan of the component of the electric vehicle or an expected lifespan of the component of the electric vehicle charger,
wherein determining that the component of the electric vehicle or the component of the electric vehicle charger should be repaired or replaced is further based on the expected lifespan of the component of the electric vehicle or the expected lifespan of the component of the electric vehicle charger.

9. A system, comprising:
one or more processors; and
memory including a plurality of computer-executable components that are executable by the one or more processors to perform a plurality of actions, the plurality of actions comprising:
receiving, from an electric vehicle, from an electric vehicle charger, and by a computing device, electric vehicle sensor data that reflects a characteristic of the electric vehicle and electric vehicle charger data that reflects a characteristic of the electric vehicle charger;
based on the electric vehicle sensor data and the electric vehicle charger data, determining, by the computing device, that a component of the electric vehicle or a component of the electric vehicle charger should be repaired or replaced; and
providing, for output by the computing device, data indicating that the component of the electric vehicle or the component of the electric vehicle charger should be repaired or replaced.

10. The system of claim 9, wherein determining that the component of the electric vehicle or the component of the electric vehicle charger should be repaired or replaced comprises:
providing, as an input to a model, the electric vehicle sensor data and the electric vehicle charger data; and
receiving, from the model, data indicating that the component of the electric vehicle or the component of the electric vehicle charger should be repaired or replaced.

11. The system of claim 10, wherein the plurality of actions comprise:
training, using machine learning and historical data that includes previous electric vehicle sensor data, previous electric vehicle charger data, and previous data indicating a repair or replacement of a component of the electric vehicle or a component of the electric vehicle charger, the model.

12. The system of claim 10, wherein the plurality of actions comprise:
receiving, by the computing device, data indicating completion of repair or replacement of the component of the electric vehicle or the component of the electric vehicle charger; and
based on (i) the data indicating completion of repair or replacement of the component of the electric vehicle or the component of the electric vehicle charger and (ii) the electric vehicle sensor data and the electric vehicle charger data, updating, using machine learning, the model.

13. The system of claim 9, wherein the plurality of actions comprise:
based on the electric vehicle sensor data and the electric vehicle charger data, determining, by the computing device, a time period when the component of the electric vehicle or the component of the electric vehicle charger should be repaired or replaced; and
providing, for output by the computing device, data indicating the time period when the component of the electric vehicle or the component of the electric vehicle charger should be repaired or replaced.

14. The system of claim 9, wherein the electric vehicle includes a receiving pad that is configured to receive power wirelessly from a charging pad of the electric vehicle charger.

15. The system of claim 9, wherein the plurality of actions comprise:
accessing, by the computing device, a service date of the component of the electric vehicle that indicates a previous repair or replacement of the component of the electric vehicle or a service date of the component of the electric vehicle charger that indicates a previous repair or replacement of the component of the electric vehicle charger,
wherein determining that the component of the electric vehicle or the component of the electric vehicle charger should be repaired or replaced is further based on the service date of the component of the electric vehicle or the service date of the component of the electric vehicle charger.

16. The system of claim 9, wherein the plurality of actions comprise:
accessing, by the computing device, an expected lifespan of the component of the electric vehicle or an expected lifespan of the component of the electric vehicle charger,
wherein determining that the component of the electric vehicle or the component of the electric vehicle charger should be repaired or replaced is further based on the expected lifespan of the component of the electric vehicle or the expected lifespan of the component of the electric vehicle charger.

17. One or more non-transitory computer-readable media of a computing device storing computer-executable instructions that upon execution cause one or more computers to perform acts comprising:
receiving, from an electric vehicle, from an electric vehicle charger, and by a computing device, electric vehicle sensor data that reflects a characteristic of the electric vehicle and electric vehicle charger data that reflects a characteristic of the electric vehicle charger;
based on the electric vehicle sensor data and the electric vehicle charger data, determining, by the computing device, that a component of the electric vehicle or a component of the electric vehicle charger should be repaired or replaced; and
providing, for output by the computing device, data indicating that the component of the electric vehicle or the component of the electric vehicle charger should be repaired or replaced.

18. The one or more non-transitory computer-readable media of claim 17, wherein determining that the component of the electric vehicle or the component of the electric vehicle charger should be repaired or replaced comprises:
providing, as an input to a model, the electric vehicle sensor data and the electric vehicle charger data; and
receiving, from the model, data indicating that the component of the electric vehicle or the component of the electric vehicle charger should be repaired or replaced.

19. The one or more non-transitory computer-readable media of claim 17, wherein the acts comprise:
based on the electric vehicle sensor data and the electric vehicle charger data, determining, by the computing device, a time period when the component of the electric vehicle or the component of the electric vehicle charger should be repaired or replaced; and
providing, for output by the computing device, data indicating the time period when the component of the electric vehicle or the component of the electric vehicle charger should be repaired or replaced.

20. The one or more non-transitory computer-readable media of claim 17, wherein the electric vehicle includes a receiving pad that is configured to receive power wirelessly from a charging pad of the electric vehicle charger.
